(19) United States
(12) Patent Application Publication
(10) Pub. No.: US 2014/0373041 A1
(43) Pub. Date: Dec. 18, 2014

(54) METHOD FOR MEDIA CONTENT DELIVERY USING VIDEO AND/OR AUDIO ON DEMAND ASSETS

(71) Applicant: THOMSON LICENSING, Issy de Moulineaux (FR)

(72) Inventor: Jane Yan, Los Angeles, CA (US)

(21) Appl. No.: 14/370,155

(22) PCT Filed: Dec. 27, 2012
(86) PCT No.: PCT/US12/71691

§ 371 Date: Jul. 1, 2014

Related U.S. Application Data
(60) Provisional application No. 61/583,601, filed on Jan. 5, 2012.

(51) Int. Cl. H04N 21/254; H04N 21/4627; H04N 21/443; H04N 21/258

(52) U.S. Cl. CPC H04N 21/2541; H04N 21/25816; H04N 21/4627; H04N 21/4431
USPC 725/27

(57) ABSTRACT

The method for media content delivery using on demand assets of a specific content provider includes integrating a user media platform with the specific content provider. This integration is established through a digital locker of the media platform and a coordinator of the specific content provider. Once established, the Digital locker of the media platform shall maintain all rights information for content purchases, in addition to also storing and maintaining those rights with the specific content provider such that purchased content may be available to the user without necessarily requiring intervention by the specific content provider.

### CROSS REFERENCE TO RELATED APPLICATIONS

This application claims priority from and the benefit of U.S. Provisional Application Ser. No. 61/583,601 filed Jan. 5, 2012, and entitled Content delivery system using Ultraviolet Media Assets, which is incorporated by reference herein in its entirety.

### BACKGROUND

1. Technical Field

The present disclosure relates to on demand systems such as video on demand (VOD) and/or Audio on demand (AOD) systems. More particularly, it relates a method and apparatus for implementing on demand (OD) content/assets in a media service platform (MSP) or media platform (MP) for delivery to end users even when not connected to the OD content provider.

2. Related Art

On demand (OD) systems such as Video on demand (VOD) or Audio on demand (AOD) are common place in today's world. The use of OD services by a computer, tablet, smartphone device, etc. has become so popular that users often expect the OD services and their purchased content to be available to the at any time.

Unfortunately the desire to have OD services/purchase content available to the user all the time is not always possible. This is primarily due to the fact that in order to access the OD purchased content, the users must not only have an account with the OD content provider, but these accounts are often tied to the specific user and/or the specific device the user registered when establishing the OD service account. This limitation results in requiring the users to also be connected to the OD Content provider coordinator in order to view, download and/or stream the purchased content.

### SUMMARY

It is an aspect of the present invention to provide a content delivery system to users such that purchased content can not only be shared with other users and other devices (i.e., not the specific registered user and/or the users' specifically registered device) in a manner that is substantially transparent to the user but may also be accessed by the user from any device at any location, and even in cases when connection to the OD content provider is not possible.

According to an implementation, the method for delivering content using a specific content provider's assets includes integrating a user media platform with a specific on demand content provider. Once integrated, a user account is created with the specific on demand content provider via the user media platform. The user media platform is linked and associated with the specific on demand content provider, and on-demand content transactions can be conducted via a user device operating the user's media platform. The rights of the purchased on demand content is recorded and posted in the Digital locker of the media platform.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1 is a block diagram of an example Video on Demand (VOD) system to which the present principles can be applied;

FIG. 2 is block diagram of an exemplary media system platform configured to deliver content in accordance with an implementation of the present principles;

FIG. 3 is a block diagram of a media system platform configured to deliver content from a content provider in accordance with an implementation of the present principles;

FIG. 4 is a flowchart of the method for delivering content to an end user according to an implementation of the present principles

FIG. 5 is a block diagram of a media system platform configured to deliver content from a content provider in accordance with another implementation of the present principles;

FIG. 6 is a block diagram of a media system platform configured to deliver content from a content provider in accordance with another implementation of the present principles;

FIG. 7 is a flowchart of the method for delivering content to an end user according to an implementation of the present principles; and

FIG. 8 is the method for delivering content to an end user according to an implementation of the present principles

It should be understood that the drawing(s) are for purposes of illustrating the concepts of the disclosure and does not necessarily represent the only possible configuration(s) for illustrating the disclosure.

### DETAILED DESCRIPTION

It should be understood that the elements shown in the figures may be implemented in various forms of hardware, software or combinations thereof. Preferably, these elements are implemented in a combination of hardware and software on one or more appropriately programmed general-purpose devices, which may include a processor, memory and input/output interfaces. Herein, the phrase “coupled” is defined to mean directly connected to or indirectly connected with through one or more intermediate components. Such intermediate components may include both hardware and software based components.

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor or controller, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

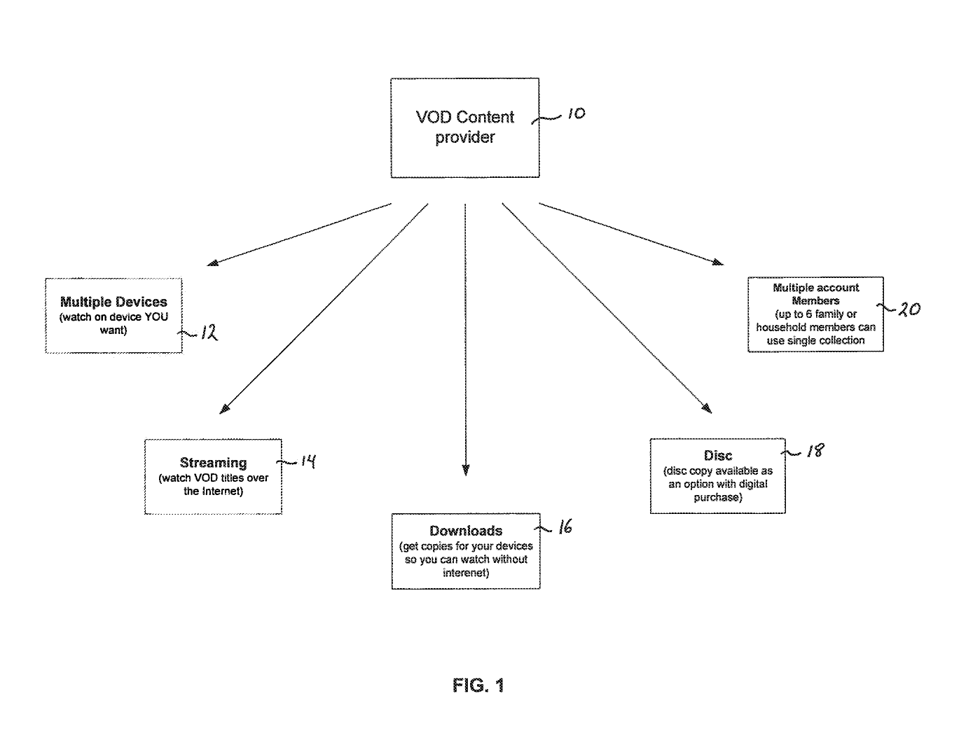

The disclosed embodiments relate to systems and methods for delivering on demand content, i.e., both video and/or audio content. FIG. 1 shows an example of an on demand network which includes the content provider 10, and various different content delivery methods. By way of example, these delivery methods can include, but are clearly not limited to: multiple devices 12 where the users watches or listens to the content on the device of their choice; streaming 14 devices where the content is retrieved by streaming over the internet; downloads 16 where the user downloads copies to a selected device so content can be watched without an internet connection; a disc copy 18 can be provide as an option to the user; and multiple account members 20 where up to 6 family members can use a single collection of on demand content.

Examples of video on demand or audio on demand content providers 10 which can be used in conjunction with the present invention can be, for example, ITUNES®, AMAZON®, ULTRAVIOLET®, NET FLIX®, etc.

By way of example, the present invention will be described in the context of a cloud based content provider. However, those of skill in the art will appreciate that the principles and concepts of the media platform disclosed herein are not limited to such cloud based provider and can be implemented with any on demand content provider. An example of such content provider is ULTRAVIOLET® which is a digital rights authentication and cloud based distribution system that allows consumers of digital home entertainment content to stream and download purchased content via multiple platforms and devices. With respect to both physical packaged media and digital media, this content provider adheres to a “buy once, play anywhere” approach that allows users to store digital proof-of-purchases under one account to enable playback of content that is platform- and point-of-sale-agnostic.

Generally speaking, the on demand content will be downloaded (or streamed) in a Common File Format (CFF), using common encryption (CENC). This format is based on the BASE ISO File Format, and ensures that a consistent set of codecs, media formats, Digital Rights Managers (DRMs), subtitling, etc. is used across the whole content provider ecosystem. In view of the fact that every title from the content provider will arrive in this format, it will generally play on any device branded by this content provider.

By way of further example the content providers establish their own Digital Entertainment Content Ecosystem (DECE) members which developed a common file format (CFF) designed to play in all players branded by that content provider and to work with all DECE-approved DRMs. The format is based on existing standards from MPEG, SMPTE, and others, and was originally derived from the Microsoft Protected Interoperable File Format (PIFF) specification. The goal was to avoid the problem of different file formats for different players and to make it possible to copy files from player to player.

Those of skill in the art will appreciate that there are three (3) profiles for files and players: portable definition (PD), standard definition (SD), and high definition (HD). A PD player will only play PD files, but an SD player will play both PD and SD files, and an HD player can play all three.

In accordance with a preferred implementation of the present principles, a media platform for delivering the on demand content to end users is provided which is configured to integrate with and be 100% compliant with third party on demand content providers such as ITUNES®, AMAZON®, ULTRAVIOLET®, NET FLIX®, etc. In order to do this various definitions and distinctions must be made.

Content provider Rights: This represents rights that a consumer has on the specific content provider's content.

Content provider Content: Content provider Content corresponds to the content that has been made available in the Content provider's coordinator. For complete compliancy, the content provider content should be made available by LASPs and DSPs in the CFF.

Content provider offers: This is an offer made by a Retailer on content available in the Coordinator and the promise to store rights in the Content provider's coordinator.

Media Platform offers: These offers can be for standard content, where rights are not stored in the specific content provider coordinator.

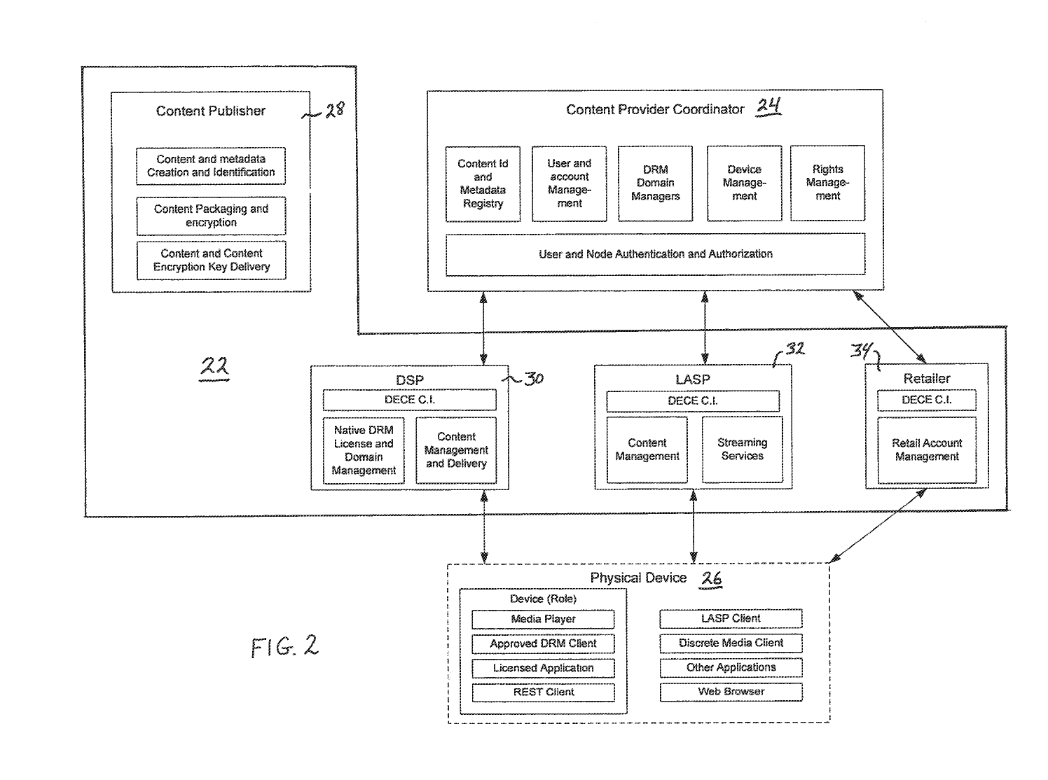

FIG. 2 shows a block diagram of the media platform 22 according to an implementation of the present principles. In this figure, the media platform 22 is shown as integrated with a specific content provider's coordinator 24 and a physical device 26. However, as will be evident from the below description, although part of a preferred implementation, such integration with the coordinator is not necessary for the media platform 22 to operate in accordance with the present principles.

The media platform 22 includes several components including a content publisher module 28, Download Service Provider (DSP) module 30, a Locker Access Streaming Provider (LASP) module 32 and a Retailer module 34.

The Download Service Provider (DSP) 30 provides services to a Retailer for delivering content to user's specific content provider players. DSP 30 provides downloads and DRM licenses and domain management, in addition to content management and delivery to the physical device 26.

The Locker Access Streaming Provider (LASP or streaming service provider) 32, such as, for example COMCAST®, is configured to stream content to user's players (i.e., physical device 26).

The physical device 26 is one or more content provider compatible players, often referred to as devices. These devices can be physical players such as web-connected TVs, Blu-ray players, mobile or smart phones, or software players that run on open systems such as PCs, tablets, etc. Some devices may be configured as Access Portals which can provide a way for user's to login to the specific content provider without going to a Web portal or to a Retailer or LASP. The device 26 can include various modules depending on the manufacturer and/or installed applications which provide features and/or functionality to the device (e.g., LASP client, Discrete media client, other apps, web browser, etc.).

The Retailer 34, such as BEST BUY® or WAL-MART®, sells the content provider's content to users by putting the right to access the content into the user's Digital locker. The retailers can sell online or in physical stores. It is anticipated that retailers can offer point of service or point of sale (cash register offers), where a user is able to pay extra money at the time a physical asset is purchases. Thus, the user can have their Digital Locker (associated with the specific content provider) automatically populated with a digital form of the physical asset if paid for. Retailers can then communicator such information to both the media platform of the present invention and/or the content provider.

The content provider coordinator 24 is specific to each content provider and there is only one for each content provider. The coordinator 24 is the central clearing house that holds information about the provider's content and the users of the content providers system. The coordinator does not store or deliver content, it only stores information about the content and who owns what. As shown, there are several modules within the coordinator 24 which include content id and metadata registry, user and account management, DRM domain managers, Device management, Rights management and a user and node authentication and authorization module.

The content publisher 28 within the media platform 22 is where the content provider (e.g., a Hollywood studio) published content for use by the content provider. The content publisher 28 is responsible for content and metadata creation and identification, content packaging and encryption and content and content encryption key delivery.

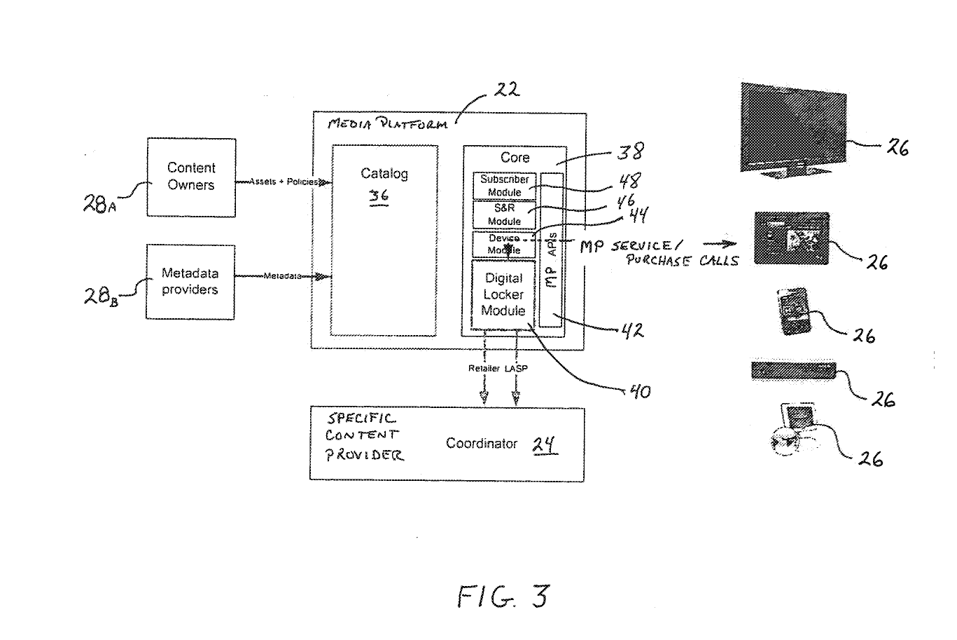

FIGS. 3, 5 and 6 shows block diagrams representing a phased approach for integrating the media platform 22 of the present principles such that it is compliant with a specific content provider's specifications. In accordance with one implementation, the media platform's digital locker 40 is extended to integrate or be bound with a specific content provider's coordinator 24, thus allowing users to receive additional benefits (e.g., in processing speeds, special offers, etc) when seeking to access content provided by the specific content provider, whether they know the content they seek to access is provided by the specific content provider or not.

The number of users for an account is not limited to one and can be more than one depending on the application (e.g., a family of 6 could all share a single account that utilized the MP of the present princples).

FIGS. 3, 5 and 6 show various devices 26 which can use the media platform 22 according to the present principles. Each device 26 preferable includes a processor or controller with a corresponding memory and/or disk storage so as to enable the operation of the media platform in accordance with the present principles. Examples of such devices are a personal computer, laptop, tablet, smartphone, network enabled television, set top box, and/or any other network enabled device having a display screen of some kind either integrated with or attached to the same. In each instance a user interface (e.g., mouse, touch screen, remote control, etc.) is provided with the respective device 26.

Referring to FIG. 3, there is shown a block diagram of the architecture of the first phase of the integration of the media platform (MP) 22 with a specific content provider's coordinator 24. This first phase consists of enabling the media platform 22 to be compliant with a specific content provider (SCP) (e.g., ULTRAVIOLET) and will allow the MP 22 to push content into the SCP coordinator 24 on behalf of content owners 28A, and also allow users to create a DECE/ specific content provider account and store rights for purchased content. As used herein, the terms “specific content provider (SCP)” and “other content provider (CP)” are intended to differentiate between the SCP and other CPs that are not integrated with the MP as is the SCP. In addition, the media platform 22 will allow users to create and associate their SCP account with their media platform account. Those of skill in the art will appreciate that “content owners” 28A, as used herein, refers to the studios creating and generating the content, and “metadata providers 28B refers to other sources (i.e. other than the studios). In some instances the content providers (e.g., studios) do provide some metadata along with the content. As will be discussed below, the media platform 22 of the present principles can receive and use metadata from the content provider 28a (e.g., for media platform licensed content), while also maintaining the ability to use metadata from other resources (i.e., metadata providers 28B) to compensate any additional information, or for other content which may not have been currently licensed by the media platform 22.

In accordance with a preferred implementation, the MP 22 will be capable of handling both SCP content and other CP content, purchasing and playing SCP content (i.e., offers having specific metadata) which will trigger calls to the SCP coordinator 24 and store the rights, and purchasing and playing other CP content.

In accordance with one implementation, the media platform (MP) 22 is made up of a catalog 36 which is a catalog of content compiled by the MP over time, and a core 38 made up of various modules which assist in the implementation and desired functionality of the MP 22. The core 38 can include a subscriber module 48, a search and recommendation (S&R) Module 46, a Device Module 44 configured to identify the various devices 26 the MP is configured to communicate with, and a Digital Locker 40 which is responsible for all interaction and integration with the specific content provider coordinator 24. The Digital Locker 40 is what enables the MP 22 to function in accordance with the present principles discussed herein. In addition, the core 38 includes the MP's application program interfaces (APIs) that enable the MP to interface with the devices 26 and handle the service/purchase calls. The catalog 36 is where the MP 22 stores the details of the purchased content (e.g., metadata, images related, etc.), and in accordance with the disclosed implementations, it is further configured to add SCP offers for the user. In accordance with one implementation, the MP 22 can provide the user with special offers such as “featured”, “our picks”, “special deals”, etc. These new offers would be handled by the MP like other offers, but will be designated as a “different type” of offer (i.e., different than an offer that does not originate from the SCP).

In accordance with a preferred implementation, the Digital Locker (DL) 40 is configured to manage the rights associated with user purchased content. Thus, the DL 40 will implemented in the following areas of operation of the device running the MP 22 according to the present disclosure: i) Rights and Status; ii) Rights Restriction & Policies; iii) Devices; iv) Encryption & Token; and v) Transactions including Purchase type and Content type.

As a result of these functions of the DL 40, it will also interface with the various modules of the MP 20 as mentioned above. By way of example, these modules include: i) the DRM for licensing delivery and management; ii) Policy Management; iii) Account Management; iv) Device Management; v) Playback, both Streaming Management and Download Management; vi) Content Management System (CMS); vii) Offer Management; viii) S&R; ix) SCP Coordinator; and x) CSR.

As will be described below, there are many different “use” scenarios relating to how the MP 22 of the present disclosure may be used once integrated with the specific content provider SCP. These scenarios include, for example, creating accounts with SCPs, linking accounts, purchasing content for download or streaming from retailers or SCPs; playback of purchased content at one or other devices; unlinking accounts, etc. For purposes of these discussions, it is understood that the Digital Locker (DL) 40 enables the various “use” scenarios by interfacing with the various modules of the MP and using the APIs to manage and communicate with the user devices (whether or not they are content provider specific). As noted above, there are several “use” cases for this implementation and which are described below with reference to additional Figures.

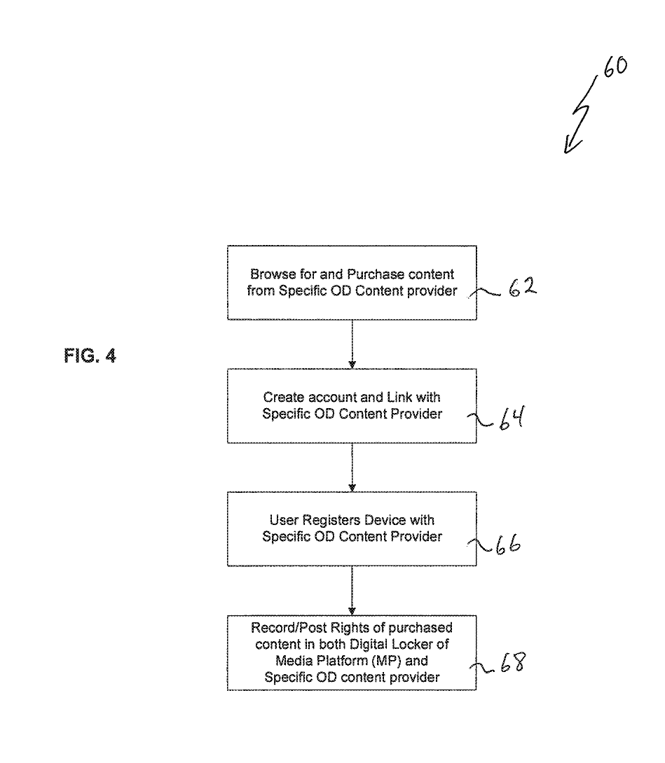

Referring to FIG. 4, there is shown an overall method 60 for creating accounts and adding and checking rights in accordance with the first phase of implementation of the present principles. Initially, a user utilizes their MP 22 to navigate to an online Retailer, browse through their content catalogue, and ultimately select content to purchase 62. Once the content is selected, then the user is prompted to “create a new account” to link with SCP (64). Here, the user selects “create a new account” and is then presented with a Retail Account Creation Form. The user enters their credentials including payment information and selects “create retail account”. At this point, the user is presented with a DECE Account Creation Form which is pre-populated with their name and other info from the Retail account just created. In some implementations, the user may be prompted to enter separate credentials depending on the OD provider requirements. At this point, once the pre-populated credentials are displayed (and any other credentials required are provider, the user selects “Create DECE account”. The DECE Account is then automatically associated with the user's Retail account.

The user is then prompted to register their device at playback of the content 66 by selecting “yes” in response to such inquiry, and the user's specific device is then added to the user's account.

Once the purchase is completed, the rights of the purchased content are recorded/posted (68) in both the user's Digital Locker 40 and the specific (on demand) content provider's coordinator 24.

A user having already established a Retailer account can then browse content on the Retailer website, select the content of their choice, and once they have entered their Retailer Account credentials, the purchased content and rights for the same are made available in their account by again recording the associated rights in the user's Digital locker 40 and the SCP coordinator 24.

If the user seeks to stream content they have purchased the rights for (whether or not those rights originated from the SCP or a other content provider) to their device running their MP (LASP), the user enters their Retailer account credentials, browses the content on the Retailer website, selects the content to play, and the content is played (i.e., streamed) assuming the rights are available in their Digital locker 40 and/or the SCP coordinator 24.

When the user selects to playback content, the MP checks with the Digital Locker 40 for rights validation. Rights validation may include, for example, purchase type (e.g., VOD, EST), Media Type (e.g., SD, HD), Device type and Policies (e.g., Windows, Streaming Restrictions, etc.) If the MP validates the rights the Digital Locker will then communicate with the DRM systems (e.g., Widevine or PlayReady) to request for licensing delivery. If successful, the Digital Locker will store the license keys and session information.

According to one implementation, based on previous validation, a request to content delivery network (CDN) will be sent, and in return a tokenized URL is provided to the user for playback based on the previously validated rights info (e.g., device type, media type, etc.). Once the URL is provided, playback is authorized.

During playback, the Digital Locker will also store the session information which, for example, includes: i) playback session (e.g., viewing window, playback position, etc.); ii) DRM key session; and iii) policy info (e.g., current device, streaming/download limits, etc.)

If the user seeks to download content they have rights for (whether or not those rights originated from the SCP or a other content provider) to their device running the MP (DPS), the user r enters their Retailer account credentials, browses the content on the Retailer website and selects the content to download. The downloaded content and rights are available for their Account (i.e., rights are recorded in the user's Digital locker 40) and available in the SCP coordinator 24. The user then can play the content locally on their device 26.

As mentioned above, the Digital Locker 40 is the source for the user's integration with an SCP (on demand-OD) coordinator 24 and the mechanism (within the MP 22) by which the user can access the content for which they have already purchased the rights. The Digital Locker 40 is integrated with the SCP by being configured to: cache rights; search and filter rights; perform ID mapping/Entertainment Identifier Registry (EIDR); and store simultaneous rights in the media platform 22 and the specific content provider coordinator 24 for content purchased from the specific content provider.

Thus, a user logged into their Account can view the rights they have in their Digital Locker via an account dashboard user interface (UI), or other GUI provided to the user within their account. When the user enters their account credentials, they can select an option such as, for example, “view rights locker” and a listing of all the content purchased for their account, regardless of who of the authorized users on the account that may have purchased it By way of example, once the user is logged in through the UI, a tab can be provided for the SCP where the user can display all their owned content in their Digital Locker (i.e., purchased through the SCP) while other tabs in the UI will contain content that was purchased through the media platform 22 (which can be both SCP and other CP content). At this point, the user may select the content and initiate a download request to the browsing device being used. Alternatively, the user could stream and/or download the content purchased and available at the media platform 22.

If the user, for some reason, desires to delete their account, they simply navigate to an accessible Account Dashboard GUI at a web portal, a Retailer or an LASP, enter their credentials, select “delete DECE account”, and confirms the account deletion. Once deleted, all members of the Account are no longer able to stream or download the content purchased to that account.

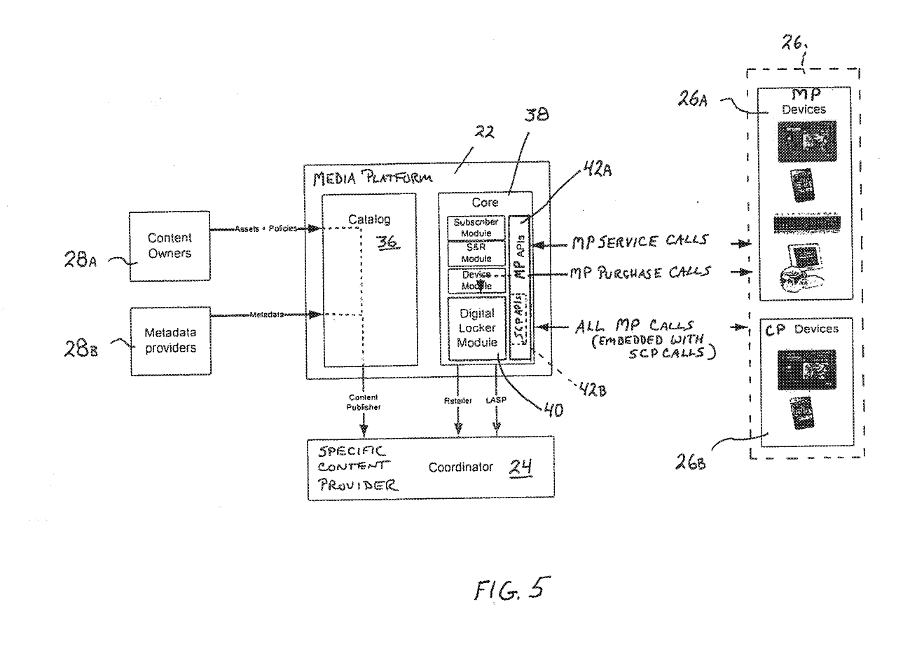

Referring to FIG. 5 there is shown a block diagram of the architecture of the second phase of the integration of the media platform (MP) 22 with a specific content provider's coordinator 24. This second phase consists of implementing the content publishing role and implementing LASP and DSP clients facing APIs, thus allowing other compatible applications to use the MP 22.

As will be evident from FIG. 5, the APIs 42 are integrated together, where the CP APIs 42b are integrated into the MP APIs 42A. The MP APIs 42A handles all MP service and purchase calls, while the CP APIs 42B are configured to handle all SCP calls that are embedded into the MP Calls. As shown, the MP APIs 42 are part of the core 38 and integrated with the Digital locker 40. In addition, the devices 26 can be separated into MP devices 26A and SCP devices 26B. In accordance with a preferred implementation, although all the devices 26 can be MP devices, they are separated here to show that it is contemplated herein that out of the MP devices 26A, some of those can be SCP certified/compliant devices 26B.

As with the first phase of implementation, there are several “use” cases associated with this second phase of implementation, which will be described below for exemplary operating purposes.

Initially the content owners can perform various functions they previously could not. By way of example, after a user of the MP purchases content, the content owners 28A can add content, update content or delete content from the SCP coordinator 24 via the MP 22.

In order to add content, the Content owners 28A provide asset and policy info to the MP 22, which transforms the metadata (from the metadata providers 28b) and communicates with the SCP coordinator 24 to add new SCP content. In order to update content in the SCP coordinator 24, the content owners 28A provide the MP 22 with different metadata. The MP 22 will transform the metadata and communicate with the SCP coordinator 24 to update the SCP content. In order to delete content, the MP 22 is again provided with metadata which includes a list of content to be deleted. The MP 22 transforms the metadata and communicates with the SCP coordinator to delete the SCP content.

In another use scenario a Retailer can provide RSS Feeds that indicate what new titles, device and promotions are available. In order to do this, the user subscribes to a Retailers Rich Site Summary (RSS) Feed for what new content is available. The user is then automatically notified that the Retailer has content available for purchase (. By way of example, this notification can take form of an email, or UI front page notification. The user selects the content and is automatically directed to the Retailer's purchasing site. The selected content is places in the user's shopping cart and the user can simply select “buy now” and the transaction is completed and the content is downloaded to their device.

Another use scenario is where the user streams their content from a DECE service to a compliant streaming device via a compliant streaming service. Here the receiving device could be a set top box (STB), PC with web browser, tablet, smartphone or any autonomous device that is compliant with streaming device requirements. By way of example, the user connects and authenticates with their Streaming Service provider (i.e., SCP via their DECE account). The user selects “view DECE content” and signs into their account with their credentials. Using the browser of the user device, the user selects a movie from her Account and selects “watch now” (note, here the user may be required to complete a transaction—optionally defined by LASP), and watches the movie.

Another use scenario is when the user purchases (actually rents in this example) a movie that can be played on any device in her Account, but only on one at a time. Here the user will browse and select a title for purchase, enter their credentials and download the move to a device 26a in her account. The user will be able to move the content among any of their devices 26a, but may only play the content on one device at a time. When the time comes and the rights for the rented content are about to expire, the Digital locker 40 will indicate to the MP user, via the respective API, that the title has expired. The user can then renew or extend the rental period, or allow the title to lapse.

If a user wants to permanently add a device to navigate to an accessible Account Dashboard, the user would login and select an option like “manage my DECE account” and enter their credentials. The user selects “add” device and now the new device is added to the list of authorized devices 26a. The user can label this newly added device however they would like.

If the user wants to temporarily add a device to their account (e.g., at a friend's house), the user can do this by using the specific content providers ID device (e.g., CP devices 26b). The user adds the device using DSP by playing the file on a friend's device. Here the DSP will check the friend's device and know that it is not in the user's account, the user can then add the device via the specific content provider's portal. Alternatively the user could add their friend to their account, but then the friend would have the same rights as the user.

In order to remove an account, the user selects “remove this device” on the device itself. This information is communicated back to the CP coordinator 24 and the device is removed from the account and any content associated with the account is no longer playable on that device.

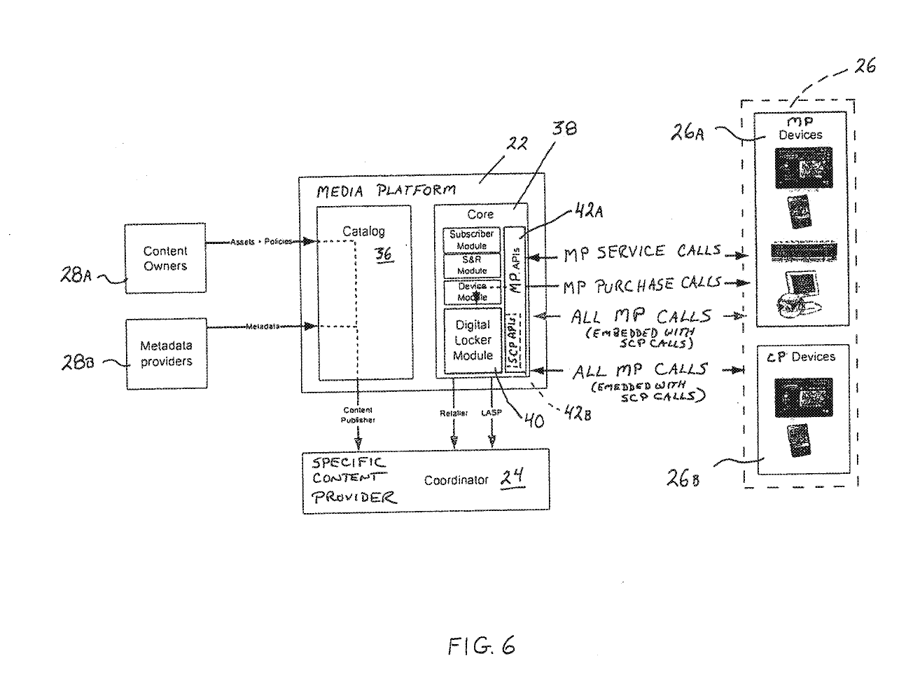

Referring to FIG. 6 there is shown a block diagram of the architecture of the third phase of the integration of the media platform (MP) 22 with a specific content provider's coordinator 24. This third phase consists of finalizing integration by making the media platform 22 compliant with the specific content provider (SCP). Essentially, the media platform 22 integrates a CFF compliant player and calls the specific content provider's services to purchase and manage the SCP content. As will be evident from FIG. 6, the MP APIs 42A are further configured to handle all SCP calls to both MP devices 26a and the CP devices 26b. In this instance, all MP Calls to either MP devices 26A or CP devices 26B are embedded with the SCP Calls.

With this implementation, the user can stream content from the MP 22 service (compliant with the specific content provider) to the MP application 42A (which is also compliant with the specific content provider), and ultimately to their device. In addition, the user can download their content from MP 22 (which is compliant with the specific content provider) to the MP API 42A (which is also compliant with the specific content provider), and view the same at the respective device 26a.

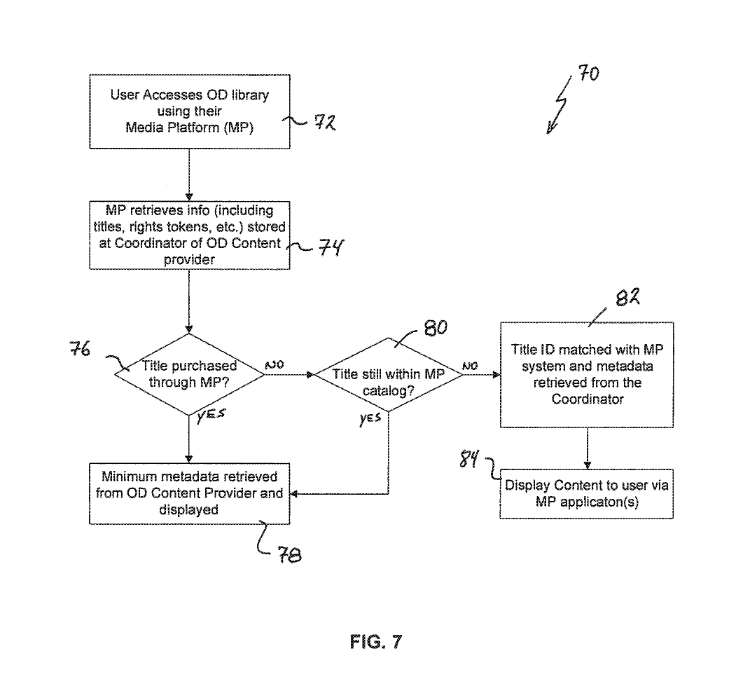

FIG. 7 provides an overview of the method 70 for content delivery in accordance with the above noted implementations. Once the user has a media platform that is integrated with a specific content provider as described above, the user initially accesses an on demand (OD) library from a specific content provider (SCP) using their media platform (72). The media platform retrieves information including titles, rights tokens, etc. from the specific OD content provider coordinator (74). A determination 76 is then made as to whether a title was purchased though the user's media platform. If yes, then this title is already contained in the user's catalog 36 and a minimum amount of metadata is retrieved (28B) from the OD content provider and displayed to the user (78). If the title was not purchased through the user's media platform (e.g., a different content provider or retailer), a determination is made whether the title is still within the user's MP Catalog 36 (i.e., rights are still available). If yes, again then a minimum amount of metadata is retrieved (28B) from the OD content provider and displayed to the user (78). If the title is not within the user's MP Catalog, the title ID is matched with the media platform system and metadata is retrieved from the coordinator directly (82). The content is they displayed 84 to the user via their Media platform application(s) 42A.

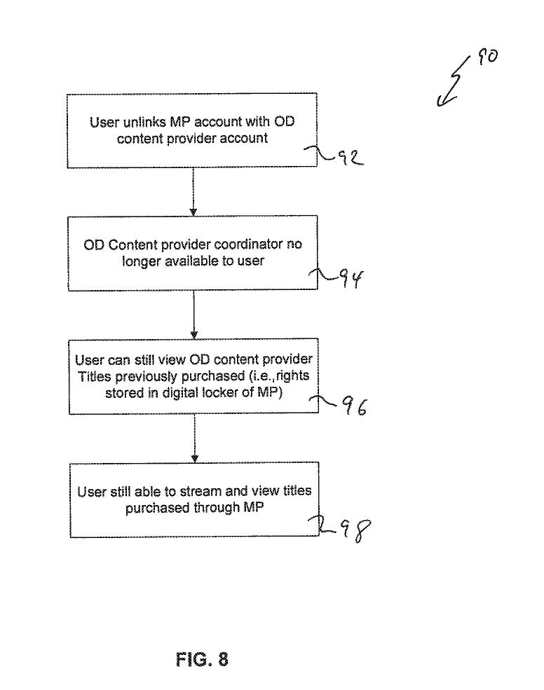

FIG. 8 shows a method 90 for delivering content to the user, even when not connected to the specific content provider (SCP). In this example, the user unlinks 92 their MP account with the specific on demand content provider. Now the specific content provider's coordinator 24 is no longer available to the user (i.e., via the user's media platform 22) 94. However, previously purchased on demand content can still be viewed 96 by the user since the rights for the same are stored in the user's Digital locker 40. For content that was purchased though the user's MP 22, this content is stored in the user's catalog 36 and the rights for the same are still stored in the Digital locker 40, and as such, the user can still view titles previously purchased and stream such content directly to their device.

As will be understood, the Digital Locker 40 of the MP 22 handles most of the events relating to the user's ability to purchase, play and manage their purchased content. By way of further examples, the Digital Locker 40 will be responsible for handling aspects of: A) Content Management System (CMS), e.g., Any further updates on content purchased will affect the DL info accordingly; B) Policy, e.g., Any further updates on content purchased (policy related) will affect the DL info accordingly; C) DRM, e.g., Any further updates on DRM system will affect the DL info accordingly; D) S&R, e.g., based on the info recorded in the DL, further recommendation and personalized content lists can be provided to the user; and E) CSR—Customer Service based on the DL info, e.g., CSR will perform some CSR activities like device management, account management, refunds, etc. As such, any CSR activities related to content will affect the rights back to the DL.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although embodiments which incorporate the teachings of the present disclosure have been shown and described in detail herein, those skilled in the art can readily devise many other varied embodiments that still incorporate these teachings. Having described preferred embodiments for a method and apparatus for media content delivery using on demand assets of a specific content provider (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

1. A method for delivering content using a specific content provider's assets, the method comprising the steps of:
integrating a user media platform with a specific on demand content provider;
creating a user account with the specific on demand content provider via the user media platform;
linking and associating the user media platform with the specific on demand content provider;
conducting an on-demand content transaction via a user device operating the user's media platform; and
recording and posting rights of purchased on demand content in a Digital Locker of the media platform.

2. The method according to claim 1, wherein said recording further comprises recording and posting rights of purchased content in a coordinator of the specific on demand content provider.

3. The method according to claim 2, wherein said linking and associating further comprises associating the user media platform with the coordinator of the specific on demand content provider.

4. The method according to claim 1, wherein said integrating further comprises configuring the media platform to be compliant with protocols of the specific on demand content provider.

5. The method according to claim 4, wherein said configuring further comprises:
enabling the digital locker of the media platform to perform the following tasks:
cache rights for content;
search and filter rights for content;
ID Mapping/EIDR; and
storing simultaneous rights in user media platform and specific content provider coordinator for all content purchased through media platform.

6. The method according to claim 1, wherein said linking further comprises registering a specific user device with the specific on demand content provider.

7. The method according to claim 1, wherein said integrating further comprises:
establishing separate application programming interfaces (APIs) for the media platform and the specific content provider, said application programming interfaces being part of a core of the media platform.

8. The method according to claim 7, wherein the separate application programming interface for the specific content provider is embedded into the media platform application programming interfaces and is configured to enable the media platform to communicate with both media platform devices and compliant specific content provider devices.

9. A computer program stored on a non-transitory computer readable storage medium, embodying instructions executable by a computer to perform method steps for controlling the delivery of on demand content to a device, the method steps comprising:
integrating a user media platform with a specific on demand content provider;
creating a user account with the specific on demand content provider via the user media platform;
linking and associating the user media platform with the specific on demand content provider;
conducting an on-demand content transaction via a user device operating the user's media platform; and
recording and posting rights of purchased on demand content in a Digital Locker of the media platform.

10. The computer program of claim 9, further comprising recording and posting rights of purchased content in a coordinator of the specific on demand content provider.

11. The computer program of claim 9, wherein said linking and associating further comprises associating the user media platform with the coordinator of the specific on demand content provider.

12. The computer program of claim 9, wherein said integrating further comprises configuring the media platform to be compliant with protocols of the specific on demand content provider.

13. The computer program of claim 12, wherein said configuring further comprises:
configuring the digital locker of the media platform to perform the following tasks:
cache rights for content;
search and filter rights for content;
ID Mapping/EIDR; and
store simultaneous rights in the user media platform and specific content provider coordinator for all content purchased through media platform.

14. The computer program of claim 9, wherein said linking further comprises registering a specific user device with the specific on demand content provider.

15. The computer program of claim 9, wherein said integrating further comprises:
establishing separate application programming interfaces (APIs) for the media platform and the specific content provider, said application programming interfaces being part of a core of the media platform.

16. The computer program of claim 15, wherein the separate application programming interface for the specific content provider is embedded into the media platform application programming interfaces and is configured to enable the media platform to communicate with both media platform devices and compliant specific content provider devices.
